(19) United States
(12) Patent Application Publication
(10) Pub. No.: US 2021/0064988 A1
(43) Pub. Date: Mar. 4, 2021

(54) RELIABILITY CALCULATION METHOD OF THE THERMAL ERROR MODEL OF A MACHINE TOOL BASED ON DEEP NEURAL NETWORK AND THE MONTE CARLO METHOD

(71) Applicant: DALIAN UNIVERSITY OF TECHNOLOGY, Dalian City, Liaoning Province (CN)

(72) Inventors: Kuo LIU, Dalian City, Liaoning Province (CN); Yongqing WANG, Dalian City, Liaoning Province (CN); Xu LI, Dalian City, Liaoning Province (CN); Bo QIN, Dalian City, Liaoning Province (CN); Yongquan GAN, Dalian City, Liaoning Province (CN); Dawei LI, Dalian City, Liaoning Province (CN); Haining LIU, Dalian City, Liaoning Province (CN)

(21) Appl. No.: 16/636,258

(22) PCT Filed: Feb. 26, 2019
(86) PCT No.: PCT/CN2019/076112

§ 371 Date: Feb. 3, 2020

(30) Foreign Application Priority Data
Feb. 20, 2019 (CN) 201910125065.1

(51) Int. Cl. G06N 3/08; G06N 3/04; G06F 17/10; G05B 19/4065

(52) U.S. Cl. CPC G06N 3/08; G06N 3/04; G05B 2219/49219; G05B 19/4065; G06F 17/10

(57) ABSTRACT

A method for calculating the reliability of the thermal error model of a machine tool based on deep neural network (DNN) and the Monte Carlo method, which belongs to the field of the thermal error compensation of computer numerical control (CNC) machine tools. Firstly, according to the probability distribution of the thermal parameters and thermal error model, a set of data for training the DNN is generated. Next, the DNN is constructed based on the deep belief networks (DBNs) and trained with the training data. Then, a group of random sampling data is obtained according to the probability distribution of the thermal characteristic parameters of the machine tool, and the group of random sampling is taken as the input and the output is obtained by the trained depth neural network. Finally, the reliability of the thermal error model is calculated based on the Monte Carlo method.

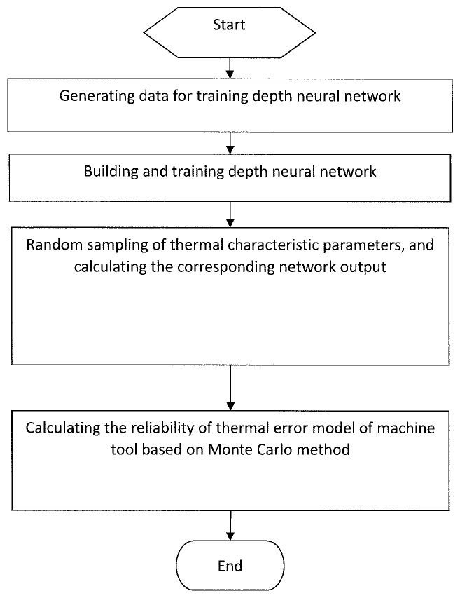

### TECHNICAL FIELD

The present invention belongs to the field of the thermal error compensation of computer numerical control (CNC) machine tools, in particular, relates to a method for calculating the reliability of the thermal error model of machine tools based on deep neural network (DNN) and the Monte Carlo method.

### BACKGROUND

In the running process of CNC machine tools, screw nuts, bearings, motors, and other components produce a lot of heat. Such heat causes the thermal deformation of the machine tool. Because of the thermal error caused by the thermal deformation of machine tools, the machining accuracy and accuracy consistency of machine tools will be poor. The thermal errors of the machine tool mainly include the feed shaft thermal error and spindle thermal error. Among them, the variation law of the thermal error of spindle is simpler, and it can be eliminated by the tool setting at every other period of time. In contrast, the change of the thermal error of the spindle is time-varying and strongly nonlinear, and it cannot be eliminated by the tool setting. Therefore, scholars have conducted much research on the thermal error modeling and compensation technology of the feed shaft. In the patent A prediction method of thermal deformation of feeding axis (Application NO. CN201711475441.7), aimed at the characteristics of energy consumption, temperature rise, and heat dissipation of the feed shaft movement, a prediction method of thermal deformation of the feed shaft was designed based on the principle of energy conservation. In the patent A thermal error prediction method for ball screw driven axis of CNC machine tools (Application NO. CN201810039994.6), the thermal error of the ball screw feed system could be predicted based on the adaptive real-time model (ARTM).

According to the characteristics of the controlled system in reality, the control model mainly includes the data-driven model and the physical driven model. In recent years, research on the thermal error modeling of the machine tool feed has shown that the physical modeling method is better than the data-driven modeling method. The thermal error model based on physics includes the thermal characteristic parameters of the screw nut pair, which are obtained by the parameter identification experiment. However, when the thermal characteristics of the machine tools change, it is not known whether the thermal error model with fixed thermal parameters is still valid. For example, (1) when the lubrication state of the lead screw changes, the calorific value of unit friction must change accordingly, but there is the question as to whether the prediction effect of the thermal error model is still accurate. (2) To facilitate the test, the protective cover of the machine tool is opened during the parameter identification test while the protective cover is closed during real-time compensation. It is unknown whether the convective heat dissipation coefficient identified when the protective cover is opened is still valid for the closed state of the protective cover. (3) According to the Stribeck friction model, the friction heat per unit length is different at different speeds. Besides, due to the different wind speed, the convective heat dissipation coefficient is also different at different moving speeds. Therefore, it is unknown whether the parameter identification test under specific speed is suitable for various speeds.

The above problems are all about the reliability of model prediction. In the reliability analysis for a general model, if the function is known, then the first and second order moments can be directly applied. However, the thermal error model of the feed shaft based on physics is very complex. The difficulty of the reliability calculation lies in that the function of the model is implicit and there is no explicit analytical expression. The traditional first and second order moment methods cannot be directly applied. Therefore, a reliability calculation method based on DNN and the Monte Carlo method is proposed to solve the reliability calculation problem of the thermal error model of the feed shaft based on physics.

### SUMMARY OF THE INVENTION

The present invention provides a method for calculating the reliability of the thermal error model of machine tools based on DNN and the Monte Carlo method given the current situation that there is no method for predicting the reliability of the thermal error model of machine tools. Using this method, the failure probability of the thermal error model of the machine tool can be calculated when the thermal characteristic parameters change.

The technical solution of the invention: Firstly, according to the probability distribution of the thermal parameters and the thermal error model, a set of data for training the DNN is generated. Then, the DNN is constructed based on the deep belief networks (DBN) and trained with the training data. Then, a group of random sampling data is obtained according to the probability distribution of the thermal characteristic parameters of the machine tool, and the group of random sampling is taken as the input and the output is obtained by the trained depth neural network. Finally, the reliability of the thermal error model can be calculated based on the Monte Carlo method. The specific steps are given below.

The first step is to generate data for training depth neural network.

(1) Generating Input Data for Training

Based on the mean value M̅ and the coefficient C of variation of the thermal characteristic parameters of the machine tool, the standard deviation S is calculated according to Equation (1).

S=M̅×C (1)

According to the probability distribution of the thermal characteristic parameters of machine tools, the mean value M̅, and the standard deviation S, a group of random sampling of the thermal characteristic parameters x(i), i=1, 2, . . . , n; are selected. The random sampling is the input data for training.

(2) Generating Output Data for Training

According to Equation (2), the thermal characteristic parameters of the machine tool are calculated, and the mean value is taken, the average prediction residual E of the thermal error model of the machine tool is as follows:

Ē=[Σₙ₌₂^{P}Σₘ₌₁^{J}|E_{c}(n,m)|]/[(p−1)×J] (2)

In Equation (2), P is the total number of the machine tool thermal error tests, J is the number of points for each test of the feed shaft of the machine tool, and E_{c} (n,m) is the predicted residual value of the m-th test point in the n-th thermal error test when the thermal characteristic parameter is taken as the mean value.

When the value of thermal characteristic parameter x(i) is calculated according to Equation (3), the average predicted residual error Ē_{Res}(i) of the thermal error model of machine tool feed shaft is as follows:

Ē_{Res}(i)=[Σₙ₌₂^{P}|E_{Res}(n,m,i)|]/[(P−1)×J], i=1,2, . . . ,n (3)

In Equation (3), E_{Res}(n, m, i) is the predicted residual value of the m-th test point in the n-th thermal error test when the thermal characteristic parameter is x(i).

Supposing that function Z(i) is

Z(i)=N−(Ē_{Res}(i)−Ē), i=1,2, . . . ,n (4)

then, N is the tolerance coefficient, and if [N−(Ē_{Res}(i)−Ē)]≤0, then it can be judged that the thermal error model of the machine tool feed shaft is “reliable”; if [N−(Ē_{Res}(i)−Ē)]>0, then it can be judged that the thermal error model of machine tool feed shaft is “failure”.

The indicator function of this function is

Z^{I}(i)=I[Z(i)], i=1,2, . . . ,n (5)

where Z^{I}(i), i=1, 2, . . . , and n is the output data for training.

Then, the second step is the construction and training of the DNN.

The DNN is constructed based on the DBN, and the DNN consists of an M-layer restricted Boltzmann machine (RBM) and a BP network.

The constructed DNN is trained based on the data {x(i),Z^{I}(i)}, i=1, 2, . . . , n. Firstly, the greedy algorithm is used to train the RBM of each layer without supervision.

Then, the feature vector of the RBM in the last layer is used as the input vector for supervised training of the BP network.

In the third step, the thermal characteristic parameters of the machine tool are randomly sampled, and the corresponding network output is calculated.

According to the probability distribution form, the mean value M̅ and the standard deviation S of thermal characteristic parameters of machine tool, xₛ(i), i=1, 2, . . . , m is generated by random sampling of these parameters, and the value of m is not less than 10⁷.

Taking xₛ(i) as the input, the output Zₛ^{I}(i), i=1, 2, . . . , and m is calculated by the trained DNN.

The fourth step is to calculate the reliability of the thermal error model based on the Monte Carlo method.

Based on data Z_{S}^{I}(i), i=1, 2, . . . , m, and according to Equation (6), the failure probability \hat{p}_{f} of the thermal error model of machine tool is

$${\hat{p}}_{f} = \frac{1}{m} {\sum }_{i = 1}^{m} {Z}_{s}^{I} ( i ) \qquad ( 6 )$$

This invention has the advantages that the influence of the change of the thermal characteristic parameters on the prediction effect of the thermal error model of the machine tool can be quantitatively analyzed, the long-term prediction effect of the thermal error model can be predicted, and the scrap rate can be reduced. Through this method, the thermal characteristic parameters that have a great influence on the prediction effect of thermal error model can be found, the design and operation conditions of machine tool can be optimized, the variation amplitude of the thermal characteristic parameters can be reduced, the prediction stability of the thermal error model can be improved, and the machining accuracy and precision stability of machine tool can be improved.

Compared with the prior art, the present invention is suitable for machine tool thermal error models that have no explicit analytic expression. It provides a scientific method for analyzing and calculating the influence of the change of thermal characteristic parameters on the prediction effect of the thermal error model, and the prediction reliability calculation problem of this kind of model is solved.

[symbol]

### DESCRIPTION OF THE DRAWINGS

The sole FIGURE is a calculation flow chart.

### DETAILED DESCRIPTION

To make the object, technical solutions, and advantages of the invention clearer, the invention will be described in detail in combination with the attached drawings. Taking the thermal error model of machine tool feed shaft shown in Equation (7) as an example, the influence of some thermal characteristic parameters changes in the model on the prediction effect can be calculated. The thermal error model of the feed axis discretizes the lead screw into M segments, and each segment length is L. For any element Lᵢ of the lead screw, the heat balance equation is as follows:

$$Δ Q ( t ) = Q ( t ) - {Q}_{c} ( t ) - {Q}_{t} ( t ) \\ Δ Q ( t ) = c ρ {L}_{i} S Δ {T}_{{L}_{i}} ( t ) \\ Q = 0.12 π {f}_{w} {υ}_{0} {nM}_{w} \\ {Q}_{c} ( t ) = h \times {S}^{′} \times ( {T}_{{L}_{i}} ( t ) - {T}_{f} ( t ) ) \times Δ t \\ {Q}_{t} ( t ) = λ \times S \times \frac{( {T}_{{L}_{i}} ( t ) - {T}_{{L}_{i + 1}} ( t ) ) + ( {T}_{{L}_{i}} ( t ) - {T}_{{L}_{i - 1}} ( t ) )}{L} \times Δ t \qquad ( 7 )$$

In these equations, Q is the heat generated by friction of Lᵢ at time t, Q_{c} is the heat exchange between Lᵢ and surrounding air at time t, Qₜ is the heat transfer between Lᵢ and microelements at both sides at time t, ΔQ is the difference between the heat generated and heat dissipation of Lᵢ, c is the specific heat capacity of lead screw, ρ is the density of lead screw, S is the equivalent cross-sectional area of lead screw, Δ_{L,}(t) is the temperature rise of Lᵢ at time t, f_{w} is the coefficient related to the type of nut and the lubrication method, υ₀ is the kinematic viscosity of the lubricant, n is the rotating speed of the lead screw, M_{w} is the total friction moment of the lead screw, h is the heat exchange coefficient, S′ is the cooling area of Lᵢ, T_{f}(t) is the air temperature in contact with the lead screw surface, and λ is the heat conduction coefficient of the lead screw.

When the machine tool is worn, the airflow around the lead screw and the lubrication changes, and the thermal characteristic parameters Q, h, and λ, may change. Therefore, the influence of these parameters' changes on the prediction effect of the thermal error model of the machine tool feed shaft is calculated.

The calculation flow is shown in the FIGURE, and the specific implementation is given below.

The first step is to generate data for training the DNN.

(1) Generating Input Data for Training

The input of the depth neural network is the thermal characteristic parameters Q, h, and λ. Let the changes of Q, h, and λ conform to the normal distribution, and their mean values are 1.04J, 15.14 W/(m²*° C.), and 4.90×10⁻⁵ W/(m*° C.), respectively. The coefficients of the variation are 0.08, 0.12, and 0.005. According to Equation (1), the standard deviations of Q, h, and λ, are S_{Q}=0.08J, Sₕ=1.8² W/(m²*° C.), and S_{λ}=2.45×10⁻⁵ W/(m*° C.), respectively.

Based on the premise of a normal distribution, according to the mean and standard deviation of Q, h, and λ, 2,000 groups of random sampling are obtained {q(i),h(i),λ(i)}(i=1, 2, . . . , 2000), that is, the input data for network training.

(2) Generating Output Data for Training

Based on the thermal error model of the machine tool feed axis, according to Equation (2), the average prediction residual Ē of the thermal error model of the feed shaft is calculated when Q, h, and λ are taken as the mean values.

According to Equation (3), the average residual Ē_{Res} (i), i=1, 2, . . . , 2000, corresponding to each group {q(i),h(i),A(i)}, is calculated.

According to Equation (3), the average residuals Ē_{Res} (i), i=1, 2, . . . , 2000, corresponding to each group {q(i),h(i),λ(i)} are calculated.

According to Equation (4) and Equation (5), the indicator function of the thermal error model function of the feed shaft of the machine tool Z^{I}(i), i=1, 2, . . . , 2000 is calculated, that is, the output data for network training.

The second step is constructing and training deep neural network.

The DNN is constructed based on the DBN. The network consists of a five-layer RBM) and a BP network. In the first RBM, there are 3 neurons in the explicit layer and 9 neurons in the implicit layer. There are 9 neurons in the explicit and implicit layers remaining in the RBM. The output vector of the RBM in the last layer is the input vector of the BP network. The BP network consists of one input layer, one hidden layer, and one output layer. The input layer contains 9 neurons, the hidden layer contains 5 neurons, and the output layer contains 2 neurons.

Based on the data {q(i),h(i),A(i),Z^{I}(i)}, i=1, 2, . . . , 2000, and the constructed deep confidence network is trained. Firstly, the gradient descent method is used for unsupervised training in the RBM of each layer, and then the eigenvector of the upper layer is used as the input vector for supervised training of the BP network.

In the third step, the thermal characteristic parameters are randomly sampled, and the corresponding network output is calculated.

Based on the premise of a normal distribution, 10⁷ groups of random sampling {qₛ(i),hₛ(i),λₛ(i)}(i=1, 2, . . . , 10⁷) can be obtained according to the mean and standard deviation of Q, h, and λ. Taking the random sampling as the input, the trained depth confidence network is applied to calculate the output Zₛ^{I}(i), i=1, 2, . . . , 10⁷.

The fourth step is to calculate the reliability of the thermal error model based on the Monte Carlo method.

Based on data Zₛ^{I}(i), i=1, 2, . . . , 10⁷, and, according to Equation (6), the failure probability of the thermal error model of the machine tool. The final calculation result is \hat{p}_{f}=0.0609.

1. A method for calculating the reliability of the thermal error model of a machine tool based on deep neural network DNN and Monte Carlo method, wherein, firstly, according to the probability distribution of the thermal parameters and thermal error model, a set of data for training the DNN is generated; next, the DNN is constructed based on the deep belief networks DBNs and trained with the training data; then, a group of random sampling data is obtained according to the probability distribution of the thermal characteristic parameters of the machine tool, and the group of random sampling is taken as the input and the output is obtained by the trained depth neural network; finally, the reliability of the thermal error model is calculated based on the Monte Carlo method; the specific steps are given below:
the first step is to generate data for training depth neural network;
(1) generating input data for training
based on the mean value M and the coefficient C of variation of the thermal characteristic parameters of the machine tool, the standard deviation S is calculated according to Equation (1);
S=M̅×C (1)
according to the probability distribution of the thermal characteristic parameters of machine tools, the mean value M̅, and the standard deviation S, a group of random sampling of the thermal characteristic parameters x(i), i=1, 2, . . . , n;
are selected; the random sampling is the input data for training;
(2) generating output data for training
according to Equation (2), the thermal characteristic parameters of the machine tool are calculated, and the mean value is taken, the average prediction residual Ē of the thermal error model of the machine tool is as follows:
Ē=[Σₙ₌₂^{P}Σₘ₌₁^{J}|E_{c}(n,m)|]/[(P−1)×J] (2)
in Equation (2), P is the total number of the machine tool thermal error tests, J is the number of points for each test of the feed shaft of the machine tool, and Ec (n,m) is the predicted residual value of the m-th test point in the n-th thermal error test when the thermal characteristic parameter is taken as the mean value;
when the value of thermal characteristic parameter x(i) is calculated according to Equation (3), the average predicted residual error Ē_{Res}(i) of the thermal error model of machine tool feed shaft is as follows:
Ē_{Res}(i)=[Σₙ₌₂^{P}Σₘ₌₁^{J}|E_{Res}(n,m,i)|]/[(P−1)×J], i=1,2, . . . ,n (3)
in Equation (3), E_{Res}(n, m, i) is the predicted residual value of the m-th test point in the n-th thermal error test when the thermal characteristic parameter is x(i);
supposing that function Z(i) is
Z(i)=N−(Ē_{Res}(i)−Ē), i=1,2, . . . ,n (4)
then, N is the tolerance coefficient, and if [N−(Ē_{Res}(i)−Ē)]≤0, then it can be judged that the thermal error model of the machine tool feed shaft is “reliable”; if [N−(Ē_{Res}(i)−Ē)]>0, then it can be judged that the thermal error model of machine tool feed shaft is “failure”;
The indicator function of this function is
Z^{I}(i)=I[Z(i)], i=1,2, . . . ,n (5)
where Z^{I}(i), i=1, 2, . . . , and n is the output data for training;
the second step is the construction and training of the DNN
the DNN is constructed based on the DBN, and the DNN consists of an m-layer restricted Boltzmann machine RBM and a BP network;
the constructed DNN is trained based on the data {x(i),Z^{I}(i)}, i=1, 2, . . . , n; firstly, the greedy algorithm is used to train the RBM of each layer without supervision; then, the feature vector of the RBM in the last layer is used as the input vector for supervised training of the BP network;
in the third step, the thermal characteristic parameters of the machine tool are randomly sampled, and the corresponding network output is calculated;
according to the probability distribution form, the mean value M̅ and the standard deviation S of thermal characteristic parameters of machine tool, xs(i), i=1, 2, . . . , m is generated by random sampling of these parameters, and the value of m is not less than 10⁷;
taking xₛ(i) as the input, the output Z_{S}^{I}(i), i=1, 2, . . . , and m is calculated by the trained DNN;
the fourth step is to calculate the reliability of the thermal error model based on the Monte Carlo method;
based on data Z_{S}^{I}(i), i=1, 2, . . . , m, and according to Equation (6), the failure probability pf of the thermal error model of machine tool is
$${\hat{p}}_{f} = \frac{1}{m} {\sum }_{i = 1}^{m} {Z}_{s}^{I} ( i ) . \qquad ( 6 )$$
